(19) United States
(12) Patent Application Publication
(10) Pub. No.: US 2004/0080890 A1
(43) Pub. Date: Apr. 29, 2004

(54) Digital instrumentation

(75) Inventors: Stephen Mark Ramsay, Sussex (GB); Renato Brian Kitchener, West Sussex (GB); Keith Romilly Roskrudge Bowden, West Sussex (GB)

Correspondence Address: HAYNES AND BOONE, LLP, 901 MAIN STREET, SUITE 3100, DALLAS, TX, 75202, US

(73) Assignee: Hawke Cable Glands Limited, Lancashire (GB)

(21) Appl. No.: 10/280,152

(22) Filed: Oct. 25, 2002

(51) Int. Cl. H02H 3/08

(52) U.S. Cl. 361/93.1

(57) ABSTRACT

A digital instrumentation system has a power supply means 36 which supplies power to at least one instrument 3 located in a hazardous area 5. Also located in the hazardous area 5 is power limiting means 27 for limiting the power supplied to each instrument 3.

The invention relates to digital instrumentation and in particular to the transmission of power to and communications to and from digital instrumentation.

Many buildings, structures, installations etc. have areas, or zones within the areas, which require process monitoring and control. These areas may be deemed hazardous as a consequence of likely contamination with an explosive or flammable gas or liquid. Potentially dangerous factors, such as sparking, arcing and temperature, need to be maintained at safe levels within hazardous areas. Monitoring and control may be carried out using instruments located in the hazardous areas, which relay information via cables to other instruments and/or controllers. On an oil production platform, for example, the temperature in an area likely to contain explosive or flammable gases may be measured by a local instrument connected to a remove controller at which a dangerously high reading will raise an alarm.

There are regulations concerning the use of electrical equipment, such as instruments, in hazardous areas. For example, in areas which may contain flammable gases, the equipment has to be protected with suitable explosion or flame proof enclosures or encapsulation, or the equipment has to be made intrinsically safe. For intrinsic safety, the supply of power to or via electrical equipment located in the hazardous area has to be limited to a level which presents no danger whatsoever. In other words, the energy levels within the equipment must be such that, say, in the event of a short circuit, there is no possibility at all of igniting any flammable gas which may be present within the area. Intrinsic safety has an advantage that electrical equipment, including instruments, can be removed from within a hazardous area without having to de-energise the supply or having to break the supply with, for example, electrical isolators.

The power supply limit demanded for intrinsic safety within any area is determined by the nature of the hazardous material(s) which are liable to occupy that area. For instance, gases are classified into groups according to their ignition characteristics. Gas groups which require the least energy to ignite demand the greatest limit on supplied power. Details of gas group classifications for intrinsic safety purposes are given in Annex A of Standard EN50014.

Recently, there has been a tendency towards instrumentation systems where a number of instruments share, or are “hung” from, the same transmission line, feed or trunk. The line is also used to convey communications signals back and forth between controllers and instruments. Generally, the instruments are DC powered and the communications signals are digitally coded AC waveforms. Usually, the AC communications signals are superimposed on the DC power voltage. There are various different types of such systems including those known in the UK under the designations HART, Foundation Fieldbus and Profibus.

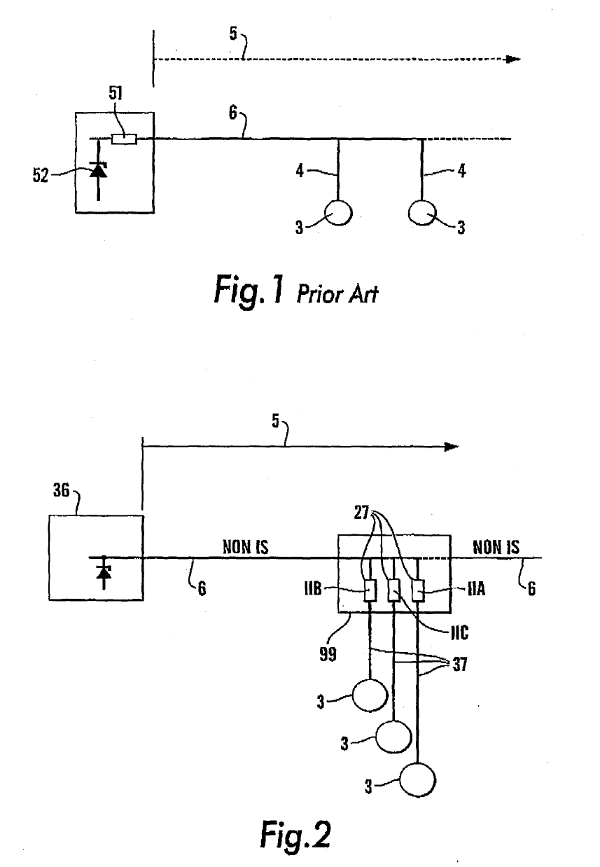

A typical intrinsically safe Fieldbus system arrangement is schematically illustrated in FIG. 1. The arrangement has a transmission line 6 by which power is transmitted on an intrinsically safe basis to two or more instruments 3 in a hazardous area 5. An infallible voltage clamp 52, consisting primarily of a Zener diode, and an infallible limiting resistor 51, limit the power transmitted by the line 6 to an intrinsically safe level. Each instrument 3 is connected to the transmission line 6 by a spur or splice 4.

A problem which has been experienced with Fieldbus and similar systems operated on an intrinsically safe basis is the limit on the number of instruments which can share a common transmission line. Fieldbus instruments typically require between 0.01 and 0.03 Amps and between 9 and 32 Volts to function. The instruments may also require, and may be certified at, a maximum power of 1.2 Watts. For an intrinsically safe transmission line, not many devices will be able to share the line before the sum of the instruments' power requirements reaches the maximum available. Taking as an example Fieldbus instruments requiring 0.02 Amps at 9 Volts minimum and an instrument matched power of 1.2 watts, operating in an area requiring a maximum of 22 Volts and 0.224 Amps for intrinsic safety, the practical maximum number of instruments for short Fieldbus transmission line lengths is approximately four. A transmission line length of 1 Km, which is not unknown in, for instance, an oil refinery, will have significant resistance and voltage may be lost proportional to the current drawn through the line. As a result, the practical maximum number of instruments may be reduced to three or less. In addition, transmission line resistance is not taken into account in the determination of intrinsic safety compliance. The DC power supply voltage needs to be maximised to allow for voltage drop along the line, which necessitates relatively high values of limiting resistors to achieve power matching with instruments hung from the line. In turn, the need for high resistance limits current.

EP0666631 discloses a digital instrumentation system in which voltage or current limitation means is provided spatially separate from a supply and the connection between the supply and the limitation means is non-intrinsically safe.

The aim of the invention is to provide an improved digital instrumentation system.

The invention provides a digital instrumentation system comprising power supply means, at least one instrument located in a hazardous area, transmission line means for transmitting power from the supply through the hazardous area to the or each instrument, power restricting means for restricting the power supplied through the transmission line means and power limiting means located in the hazardous area for limiting the power delivered from the transmission line to at least one of the at least one instruments.

By locating the power limiting means “downstream” in the transmission line means, that is, remote from the power supply means, the power in the line means may be kept high, thereby maximising the line length and/or the number of instruments sharing the line means. The power limiting means may limit the power delivered to the at least one instrument to an intrinsically safe level for the hazardous area. Alternatively, the power limiting means may limit the power delivered to the at least one instrument to below an intrinsically safe level. In the event, say, of an instrument short circuiting to a resistive load, power at an intrinsically safe level may still be sufficient to raise the temperature of the instrument to a dangerous level, and further limiting the power may prevent this eventuality.

Preferably, the power limiting means comprises current limiting means, which preferably comprises resistor means. The current limiting means may additionally or alternatively comprise fuse means and/or switch means. Each at least one instrument may have current limiting means dedicated to it.

The power limiting means may additionally or alternatively comprise voltage limiting means for clamping the voltage delivered to the or each instrument. The voltage limiting means may comprise a Zener diode based voltage clamp or any other similar or equivalent form of voltage clamp.

The voltage of the basis of which intrinsic safety compliance is assessed for a hazardous area or zone in which an instrument is located is the voltage at the point of intrinsically safe entry into the area or zone. Power limiting means including voltage limiting means enables the voltage delivered by the power limiting means at the point of intrinsically safe entry into the area or zone to be lower than the voltage output by the power supply means. Having a lower voltage at that point enables lower current limiting resistor means to be used to match the power requirements with the instruments, and current is not excessively limited.

The power limiting means may deliver power to a plurality of instruments and each one of the instruments may be located in a zone within the hazardous area of the same or of a different intrinsic safety requirement to any one of the other zones within the area. The instruments could be in a star or multi-drop configuration. Power from the power limiting means may be delivered not only to the or each instrument but also to other power limiting means, located in the same or another hazardous area, in turn delivering power to other instruments.

Preferably, the power level restricting means limits the power supplied along the transmission line to an intrinsically safe level for a zone within the area between the power supply means and the power limiting means. The at least one instrument may be located in a zone of a different, typically more stringent, intrinsic safety requirement to the zone between the power supply means and the power limiting means. In other words, the power limiting is preferably achieved in a two-stage process, taking advantage of the maximum allowable power in each zone and yet maintaining intrinsic safety in each zone.

The power restricting means preferably comprises current clamping means, which preferably comprises resistor means. The current clamping means may alternatively or additionally comprise fuse means and/or switch means. The fuse and/or switch means may be thermally actuated. The power level restricting means may alternatively or additionally comprise voltage clamping means, which may comprise a Zener diode based voltage clamp or any other similar or equivalent form of voltage clamp. Thermal actuation of the fuse and/or switch means may be in response to the temperature of the voltage clamping means.

Further preferably, when the power limiting means and the power restricting means both comprise resistor means, the values of the resistor means are matched respectively so as to maximise power transference between the power supply means and the at least one instrument.

Additionally preferably, the system comprises voltage regulating means for regulating the voltage input from the transmission line to the power limiting means. The voltage regulating means may be in a series or parallel configuration. In a parallel configuration, the voltage regulating means may have a high impedance to digital or AC signals and/or high frequency voltage components and low resistance to DC voltages. In other words, the voltage regulating means may act as a low pass voltage shunt regulator that only limits DC voltages and AC voltages up to a predetermined threshold, allowing the AC communications signals, about the threshold, to pass unaffected. Voltage regulating means comprising an inductor and a Zener diode in a parallel configuration will act as a low pass voltage shunt regulator. In a series configuration, the voltage regulating means may comprise a field effect transistor.

The voltage regulating means is intended to limit the DC level of the power supply means to below the intrinsically safe voltage clamping level imposed by the power limiting means including voltage limiting means, so as to prevent the voltage limiting means from adversely affecting, clamping or clipping the AC communication signals.

The system may further comprise additional current limiting means between the power supply means and the power limiting means. The additional current limiting means may comprise resistor means and/or fuse means.

The system may further comprise a converter.

The power supply means may be located in a safe area. The power supply means may comprise a digital input/output segment connected via a coupler, for example, a transformer, to the transmission line. The coupler may have two or three galvanically isolated circuits and may support one or more transmission lines. The digital input/output segment may be protected by intrinsically safe isolation, in which case the galvanic isolation of the coupler to the transmission line may not be required. Power may be supplied to the one or more transmission lines via the coupler from one or more power supplies, which may be common power supplies. The power supplies may be protected by intrinsically safe galvanic isolation, in which case galvanic isolation of the power supply may not be required. Alternatively, a coupler may have its own power supply, on-board or off-board, with power supplied directly to the coupler. More than one coupler may be attached to a single segment and the attachment of the segment may be by a bus so as to form a daisy-chained, bridged or multi-dropped connection of the couplers to the bus.

The invention will now be described by way of example with reference to the following drawings in which:

FIG. 1 is a schematic illustration of a prior art intrinsically safe Fieldbus digital instrumentation system;

FIG. 2 is a schematic illustration of a digital instrumentation system;

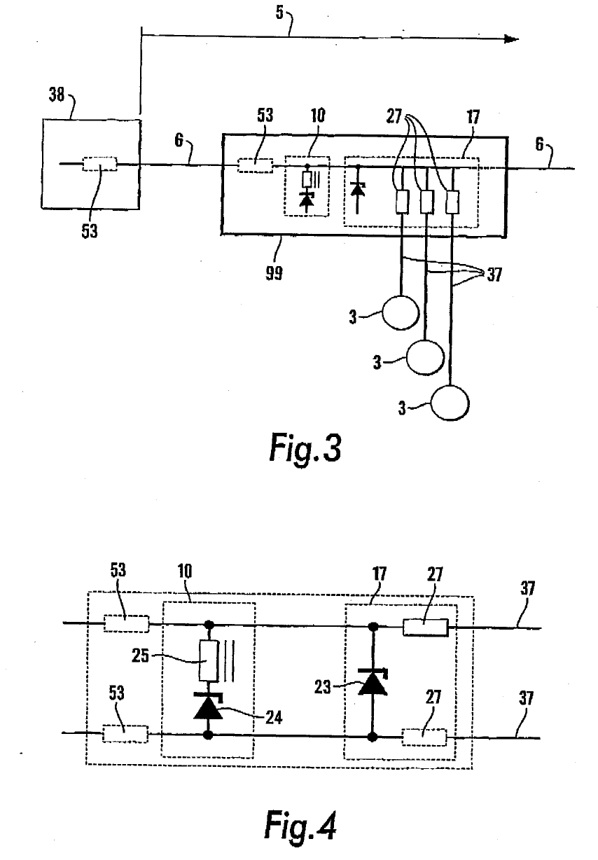

FIG. 3 is a schematic illustration of another digital instrumentation system;

FIG. 4 is a schematic illustration of the voltage regulating and power limiting means utilised in the systems shown in FIGS. 2 and 3;

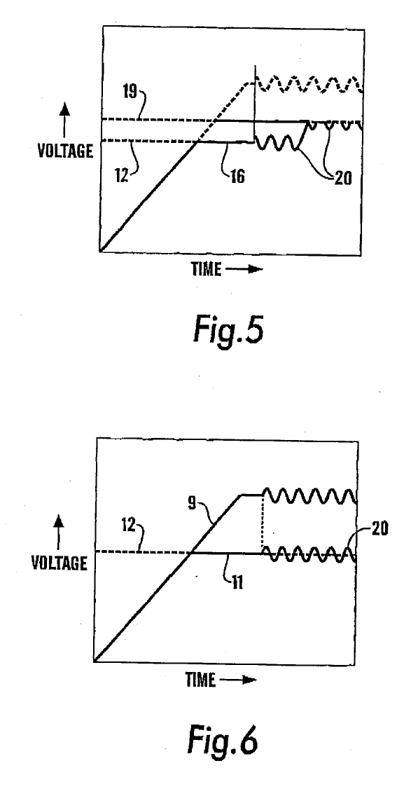

FIG. 5 is a graphical illustration of the effects on voltages of the power limiting means shown in FIG. 4;

FIG. 6 is a graphical illustration of the effects on voltages of the voltage regulating means shown in FIG. 4;

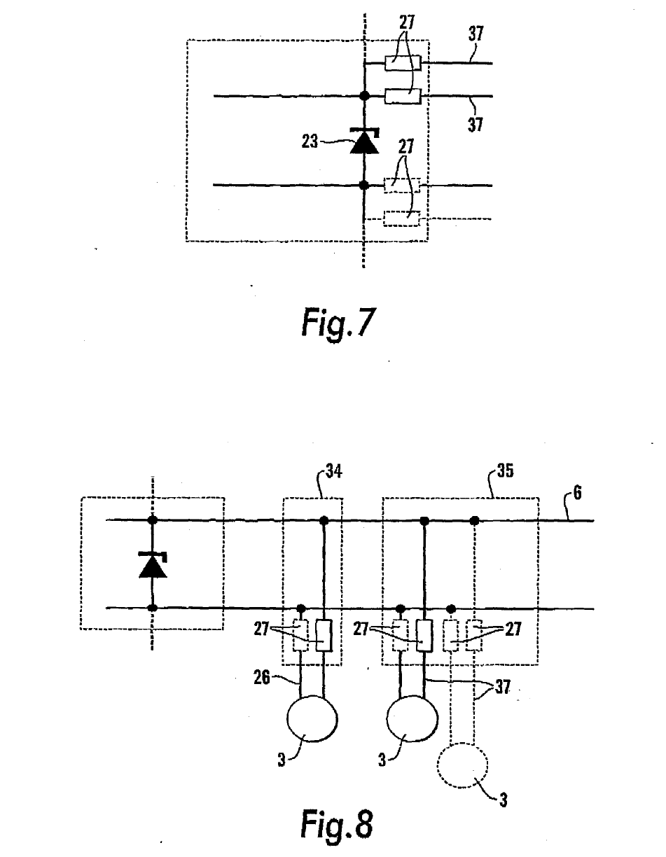

FIG. 7 is a schematic illustration of one configuration of the outputs from the power limiting means shown in FIG. 4;

FIG. 8 is a schematic illustration of an alternative configuration of the outputs from the power limiting means shown in FIG. 4;

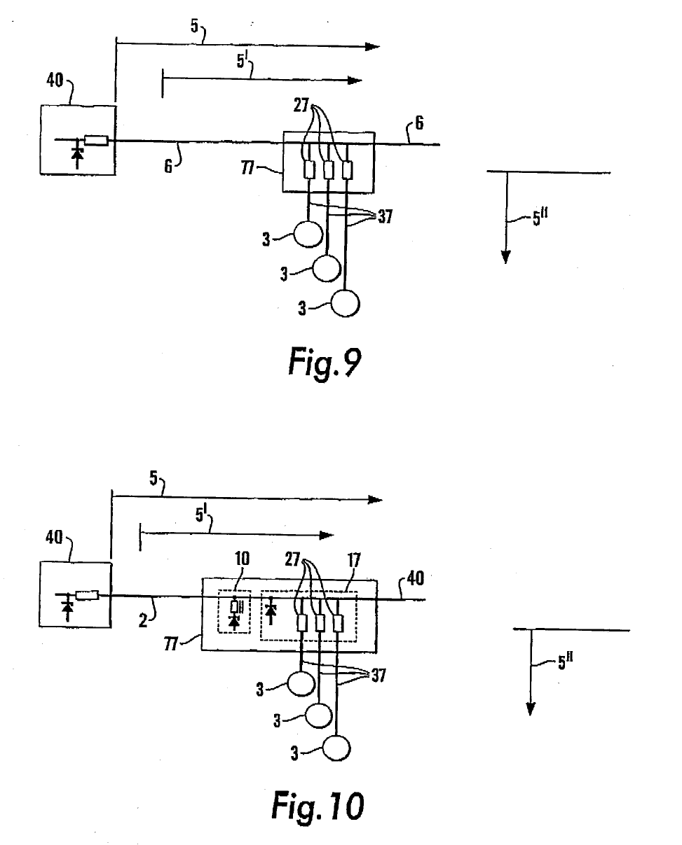

FIG. 9 is a schematic illustration of a digital instrumentation system according to the invention;

FIG. 10 is a schematic illustration of another digital instrumentation system according to the invention;

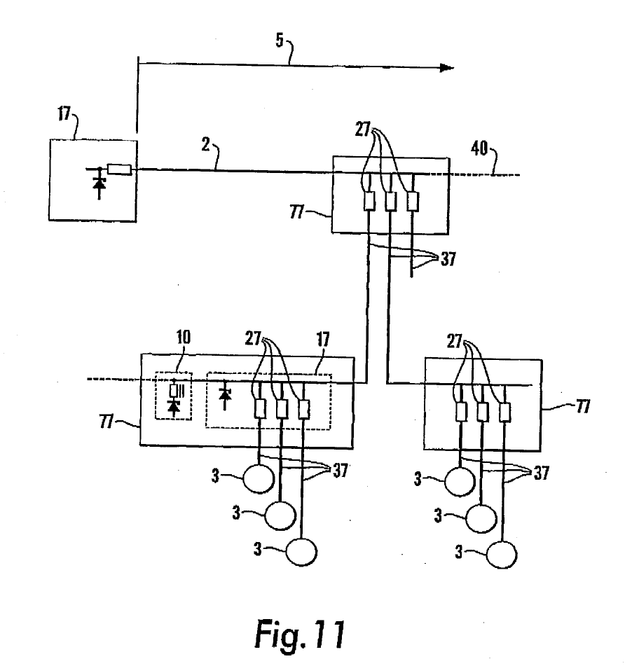

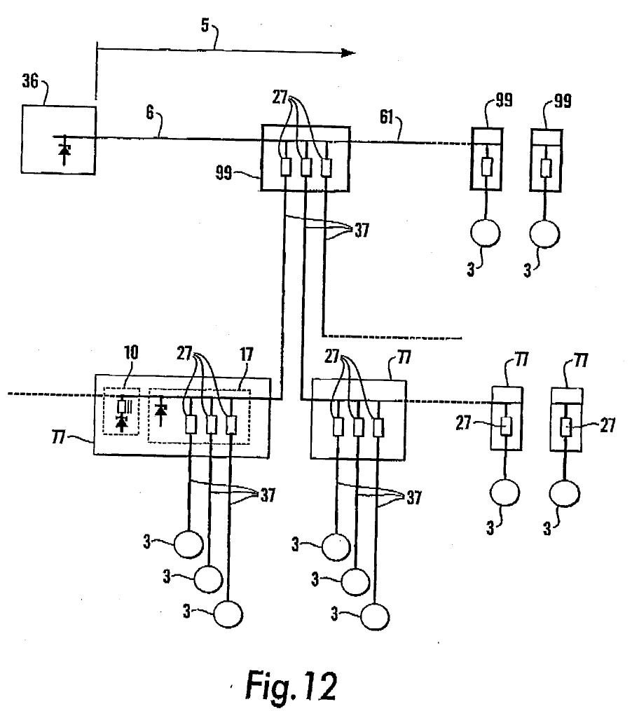

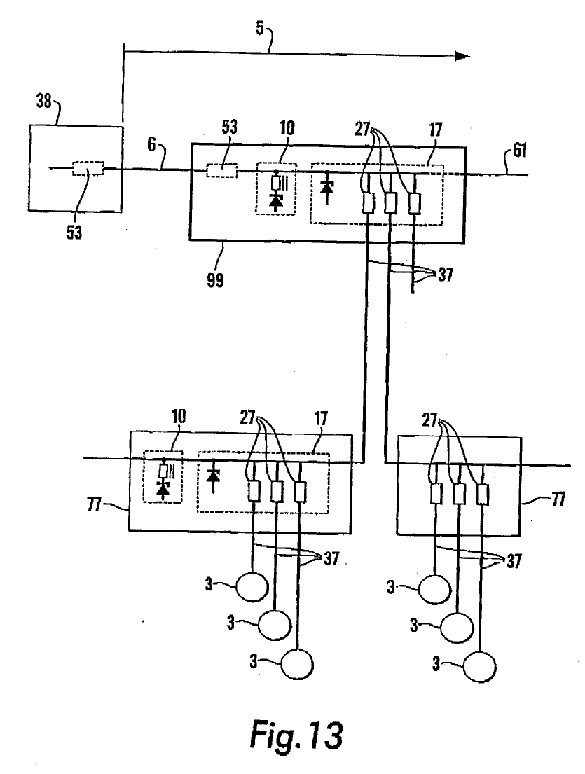

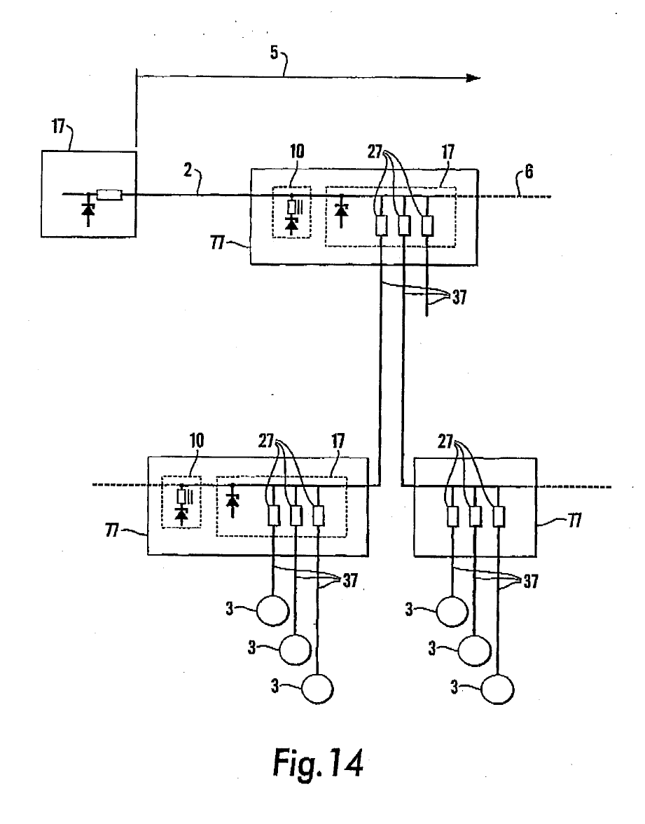

FIGS. 11-14 are schematic illustrations of other digital instrumentation systems;

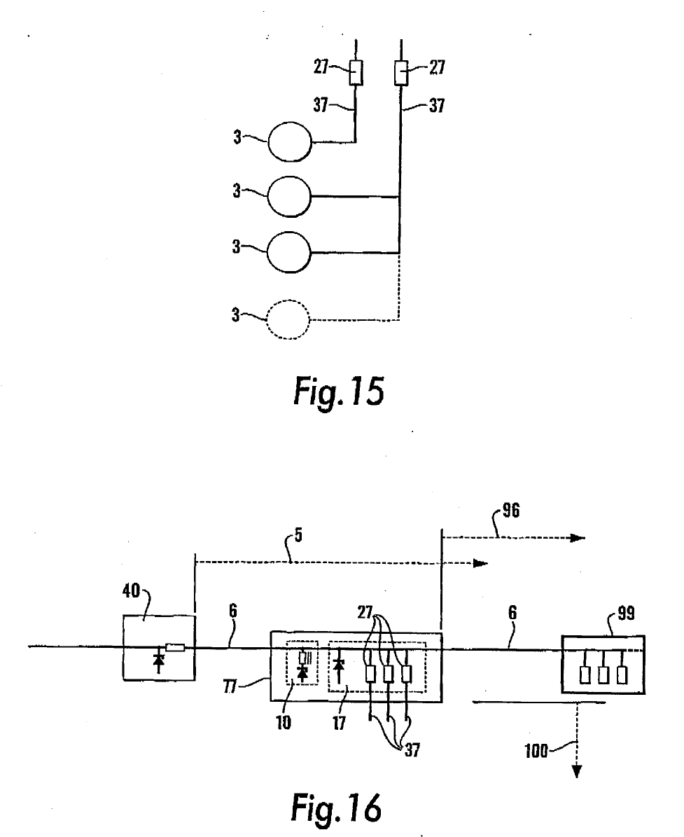

FIG. 15 is a schematic illustration of configurations of instrument connections to outputs in a digital instrumentation system according to the invention;

FIG. 16 is a schematic illustration of yet another digital instrumentation system according to the invention;

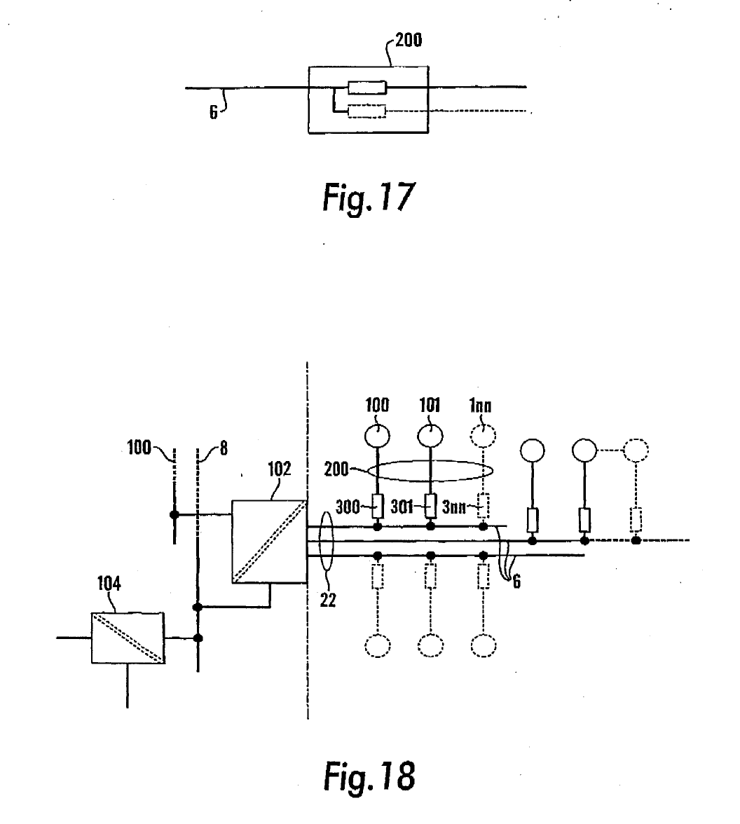

FIG. 17 is a schematic illustration of a converter for use in conjunction with a digital instrumentation system according to the invention;

FIG. 18 is a schematic illustration of power supply means for a digital instrumentation system according to the invention; and

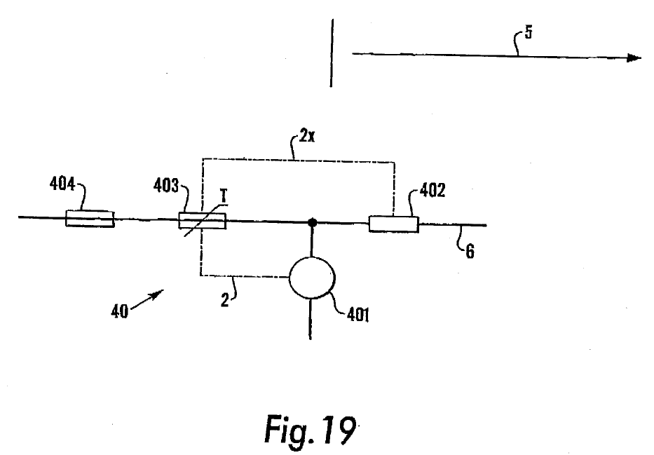

FIG. 19 is a schematic illustration of power supply means for a digital instrumentation system according to the invention.

With reference to FIG. 2, DC power from a non-intrinsically safe, voltage clamped supply 36 located in a safe, non-hazardous area (that is to the left of the line delimiting hazardous area 5) is transmitted via a transmission line 6 through the hazardous area 5 to three instruments 3 located in the hazardous area 5. As the output from the supply 36 is at a non-intrinsically safe level for the hazardous area 5, suitable protection, such as explosion proof cladding, has to be provided for the transmission line 6. Power is delivered from transmission line 6 to each of the instruments 3 via a spur and an associated output 37 respectively. Superimposed upon the DC level of the power supply voltage are AC communications signals carrying information back and forth between a controller (not shown) and the instruments 3. In each spur, there is power limiting means in the form of a current limiting resistor 27 also located in the hazardous area 5. All three resistors 27 and the junction between the line 6 and the spurs are, because of the non-intrinsically safe level of the power, housed in a suitably protected enclosures 99. The outputs 37 are, as a result of the current limiting imposed by their associated resistors 27, each intrinsically safe for the hazardous area 5. Thus, power to the instruments is not limited to an intrinsically safe level until downstream in the line 6, away from the power supply 36, so that the power level on the transmission line 6 may be kept high, thereby maximising the length of transmission line 6 and the number of instruments sharing the transmission line 6. The transmission line 6 continues beyond the position of the spurs to other spurs (not shown) to which instruments are connected.

With reference to FIG. 3, power from a non-intrinsically safe, non-voltage-clamped supply 38 is transmitted via transmission line 6 through the hazardous area 5 to three instruments 3 located in the hazardous area 5. As the output from the supply 38 is at a non-intrinsically safe level for the hazardous area 5, suitable protection has to be provided for the transmission line 6. Power is delivered from the transmission line 6 to each of the instruments 3 via a spur and an associated output 37. Superimposed upon the DC level of the power supply voltage are AC communications signals carrying information back and forth between a controller (not shown) and the instruments 3. The power is delivered via power limiting means 17 also located in the hazardous area 5. The power limiting means 17 includes current limiting resistors 27 and voltage limiting circuitry which clamps the voltage delivered on each output 37. In addition, the power to the power limiting means 17 is fed through voltage regulating means 10 also located in the hazardous area 5. The power limiting means 17 and the voltage regulating means 10 are, because of the non-intrinsically safe level of the power, both housed in the same suitably protected enclosure 99. The power limiting means 17 limits the power output on each of the outputs 37 to an intrinsically safe level for the hazardous area 5. The voltage regulating means 10 ensures that the DC level of the power supply voltage fed to the power limiting means 17 is limited or pulled down to a level at which the power limiting means 17 will not adversely affect, clamp or clip the AC communications signal superimposed on the DC voltage level. The transmission line 6 continues beyond the position of the spurs to other spurs (not shown) to which instruments are connected.

As the determination of compliance with the intrinsic safety level demanded for the hazardous area 5 is based upon the clamped voltage of the power limiting means 17, which can be much lower than the voltage output by the power supply 38, the resistors 27 in the power limiting means 17 can be lower than would otherwise be required to match the power requirements of the instruments 3, so that current is not excessively limited.

Illustrated in FIG. 4 is an example of a suitable equivalent circuit for achieving the power limiting and voltage regulating functions utilised in the arrangements described above with reference to FIG. 3. The power limiting means 17 includes a Zener diode voltage clamp 23 and at least one current limiting resistor 27. The clamp 23 will limit both the AC and DC voltage that may pass in either direction through the power limiting means 17. This means that not only the DC voltage used to power any instrument 3 but also the AC communications voltages, superimposed upon the DC voltage, will be limited. FIG. 5 illustrates graphically the behaviour of the power limiting means 17 which has an absolute voltage threshold 19 such that when the level of the DC voltage fed to the voltage clamp 23 rises from a normal working level 12 to close to, at or above the absolute limit 19, the AC communications signal 20, superimposed upon the DC voltage 16, may be affected, more specifically, clipped. To avoid this problem voltage regulating means 10, illustrated in FIG. 4 as including an inductor 25 and Zener diode 24, is used to limit or pull down the voltage fed to the power limiting means 17. FIG. 6 illustrates graphically how the voltage regulating means limits the DC power supply voltage, irrespective of the input voltage as shown at 9, so as to provide sufficient “headroom” to prevent the AC communications signal ever exceeding the absolute limit 19. At the same time, the AC communications signal 20 remains unaffected by the voltage regulating means 10.

Optional one or more resistances 53, shown in FIGS. 3 and 4, in advance of the voltage regulating means 10, could be integral resistances and/or transmission line resistances and/or within the power supply where they may also perform a current limiting and/or power limiting function.

FIG. 7 illustrates power limiting means as described above with reference to FIGS. 4-6, with the outputs 37 in a so-called star configuration. The intrinsic safety rating of each output 37 will depend upon the maximum voltage allowable by the clamp 23 and the value of the associated resistor 27. The value of the resistors 27 are therefore chosen to limit power as appropriate to the area which the outputs will enter respectively and to match power requirements. Each resistor 27 can consist of one or more resistors, which may be substituted with or supplemented by one or more fuses.

FIG. 8 illustrates an alternative configuration of the power limiting means shown in FIG. 7, with the outputs 37 in a so-called multi-drop configuration. The outputs 37 deliver power directly to instruments 3 or to other power limiting means. The resistors 27 can be housed collectively, along with their respective junctions to the transmission line 6, in a suitable enclosure 35 or individually in a suitable enclosure 34. Beyond the enclosures 35, the transmission line 6 continues on to other spurs (not shown). Again, each resistor 27 can consist of one or more resistors, which may be substituted with or supplemented by one or more fuses.

An embodiment of the invention is illustrated in FIG. 9. Power from the supply 40 is restricted by power restricting means to an intrinsically safe level for the zone 5′ with the hazardous area 5. The power restricting means comprises a Zener diode voltage clamp 41 and a current clamping resistor 42. The intrinsically safe power is transmitted through the zone 5′ to three instruments 3 located in a zone 5″ within the hazardous area 5, which has a more stringent intrinsic safety requirement than zone 5′. Power is delivered from transmission line 6 to each of the instruments 3 via a spur and associated output 37 respectively. Superimposed upon the DC level of the power supply voltage are AC communications signals carrying information back and forth between a controller (not shown) and the instruments 3. In each spur, there is power limiting means in the form of a current limiting resistor 27 also located in the hazardous area 5′. All three resistors 27 and the junctions between the line 6 and the spurs are housed in an intrinsically safe with respect to the safety requirements of the zone 5′, between the supply 40 and the enclosure 77. The power limiting means 27 is required in order to meet the more stringent intrinsic safety requirements of the zone 5″, in which the instruments 3 are located. Thus, the resistors 27, by further limiting the power transmitted on the line 6, render the outputs 37 intrinsically safe for the area 5″. In other words, the power is stepped down to the requirements of the zone 5″. In a two stage process according to the safety requirements of the zones 5′, 5″ through which the power is transmitted and taking advantage of the maximum allowable power in each zone 5′, 5″. Moreover, the values of the power restricting resistor 42 and the power limiting resistor 27 are matched so as to ensure maximum power transference from the supply 40 to the instruments 3.

FIG. 10 illustrates a further embodiment of the invention, a variation on the embodiment described above with reference to FIG. 9, wherein power from an intrinsically safe supply 40 is transmitted through a zone 5′ of one intrinsic safety level to an intrinsically safe enclosure 77 where it is voltage regulated at voltage regulating means 10, voltage and current clamped at power limiting means 17, all in the manner mentioned with reference to FIGS. 5-7, so as to render it intrinsically safe for delivery on outputs 37 through a zone 5″ of more stringent safety requirements, in which instruments 3 are located.

FIGS. 11-14 illustrate further variations on the arrangements described above (with like parts having been given the same reference numerals), in which each of the outputs 37, instead of being connected to an instrument 3, is connected to further power limiting means of the types also described above.

FIG. 15 illustrates the possibility, in any of the arrangements described above, of connecting one, two or more devices 3 to each output 37.

FIG. 16 illustrates a further variation on the arrangements described above in which a transmission line 6 output from the power limiting means 17 transmits power on a non-intrinsically safe basis through a further hazardous area 96 to further current limiting means for limiting power delivered to further instruments (not shown) in a hazardous area 100 of a different intrinsic safety level rating to area 96.

FIG. 17 schematically illustrates a converter 200 which may be utilised in a system according to the invention, for instance, in a situation where conversion is required of the power supplied on a line 6, say, from a non-intrinsically safe level to an intrinsically safe level for a first zone and then, using power limiting means according to the invention, limiting the power to an intrinsically safe level for a second zone, of a more stringent safety level than the first. The converter 200 may have more than one output for each input.

In each of the arrangements described above, the power supply means located in the safe area, which should be understood to include digital communications signals input/output means, may take, as an example, the form illustrated in FIG. 18. A single digital input/output segment (not shown) is connected using a bus 100 via a coupler 102 to multiple transmission lines 6 each having power limiting means as described above with reference to any of the embodiments of the invention. the coupler 102, which comprises an infallible transformer, has two intrinsically safe galvanically isolated circuits. Power is supplied to the transmission lines 6 via the coupler 102 from one or more shared or common power supplies 104, which also each comprise an infallible transformer, located in the safe area, each having intrinsically safe galvanic isolation.

Illustrated in FIG. 19 is intrinsically safe power supply means 40 for delivery power on transmission line 6 which is at an intrinsically safe level for area 5. The power supplied is restricted by power safety level restricting means comprising a voltage clamp 401 and a current limiting resistor 402. A thermal switch or fuse 403 ‘upstream’ or ‘downstream’ in the line 6 or in the return is thermally coupled to the voltage clamp 401. In the event that the voltage 401 becomes excessively hot, the switch or fuse 403 is actuated so as to cut off the current to the voltage clamp 401. The voltage clamp 401 may comprise a Zener diode of a high wattage capacity, which would typically be used in conjunction with a correspondingly high capacity, and consequently space consuming, heat sink. Having thermal protection negates the need for such a heat sink and therefore reduces space requirements. The switch or fuse 403 may also be thermally coupled to the resistor 402 and an additional fuse 404 may be provided upstream or downstream of the switch or fuse 403.

1. A digital instrumentation system comprising power supply means, at least one instrument located in a hazardous area, transmission line means for transmitting power from the supply through the hazardous area to the at least one instrument, power restricting means for restricting the power supplied through the transmission line means and power limiting means located in the hazardous area for limiting the power delivered from the transmission line to at least one of the at least one instruments.

2. A system according to claim 1 wherein the power limiting means comprises current limiting means.

3. A system according to claim 2 wherein the current limiting means comprises resistor means.

4. A system according to claim 3 wherein the current limiting means additionally or alternatively comprise fuse means and/or switch means.

5. A system according to claim 1 wherein each at least one instrument has dedicated current limiting means.

6. A system according to claim 2 wherein the power limiting means additionally or alternatively compresses voltage limiting means.

7. A system according to claim 6 wherein the voltage limiting means comprises a Zener diode based voltage clamp or any other voltage clamp.

8. A system according to claim 1 wherein the power limiting means delivers power to a plurality of instruments and each one of the instruments is located in a zone within the hazardous area of the same or of a different intrinsic safety requirement to any one of the other zones within the area.

9. A system according to claim 8 wherein the plurality of instruments are in a star or multi-drop configuration.

10. A system according to claim 1 wherein power from the power limiting means is delivered to other power limiting means, located in the same or another hazardous area, in turn delivering power to another at least one instrument.

11. A system according to claim 1 wherein the power level restricting means restricts the power supplied along the transmission line to an intrinsically safe level for a zone within the area between the power supply means and the power limiting means.

12. A system according to claim 11 wherein the or each at least one instrument is located in a zone of a different intrinsic safety requirement to the zone between the power supply means and the power limiting means.

13. A system according to claim 1 wherein the power restricting means comprises current clamping means.

14. A system according to claim 13 wherein the current clamping means comprises resistor means.

15. A system according to claim 14 wherein the current clamping means alternatively or additionally comprises fuse means and/or switch means.

16. A system according to claim 15 wherein the fuse and/or switch means are thermally actuated.

17. A system according to claim 14 wherein the power restricting means alternatively or additionally comprises voltage clamping means.

18. A system according to claim 17 wherein the voltage clamping means comprises a Zener diode based voltage clamp or any other voltage clamp.

19. A system according to claim 1 wherein the power limiting means comprises resistor means and the power restricting means comprises resistor means, and the values of the power limiting resistor means and the power restricting resistor means are matched thereby to maximize power transference between the power supply means and the or each at least one instrument.

20. A system according to claim 1 comprising voltage regulating means for regulating the voltage input from the transmission line to the power limiting means.

21. A system according to claim 20 wherein the voltage regulating means may be in a series or parallel configuration.

22. A system according to claim 21 wherein the voltage regulating means, in a parallel configuration, has a high impedance to digital or AC signals and/or high frequency voltage components and low resistance to DC voltages.

23. A system according to claim 22 wherein the voltage regulating means comprises an inductor and a Zener diode.

24. A system according to claim 20 wherein the voltage regulating means, in a series configuration, comprises a field effect transistor.

25. A system according to claim 1 comprising additional current limiting means between the power supply means and the power limiting means.

26. A system according to claim 25 wherein the additional current limiting means comprises resistor means and/or fuse means and/or switch means.
